(19) United States
(12) Patent Application Publication
(10) Pub. No.: US 2025/0175813 A1
(43) Pub. Date: May 29, 2025

(54) APPARATUS AND METHOD FOR SEARCHING BEAM BASED ON NETWORK CONTROLLED REPEATER IN WIRELESS COMMUNICATION SYSTEM

(71) Applicant: ELECTRONICS AND TELECOMMUNICATIONS RESEARCH INSTITUTE, Daejeon (KR)

(72) Inventor: Jung Pil CHOI, Daejeon (KR)

(21) Appl. No.: 18/962,944

(22) Filed: Nov. 27, 2024

(30) Foreign Application Priority Data
Nov. 29, 2023 (KR) 10-2023-0169868
Nov. 4, 2024 (KR) 10-2024-0154499

(51) Int. Cl. H04W 16/28; H04W 24/02; H04W 74/0808

(52) U.S. Cl. CPC H04W 16/28; H04W 24/02; H04W 74/0808

(57) ABSTRACT

Proposed are an apparatus and a method for NCR-based beam search in a wireless communication system. A beam search procedure performed by a network-controlled repeater (NCR) in a wireless communication system includes performing carrier sensing under control of a base station to set a communication-possible area, limiting a beam candidate group on the basis of the communication-possible area to shorten the time taken for beam search, and continuing the carrier sensing even after the beam search procedure is initiated, to update the beam candidate group.

### TECHNOLOGY FIELD

The present disclosure relates generally to a wireless communication system. More particularly, the present disclosure relates to an apparatus and a method for network-controlled repeater (NCR)-based beam search in a wireless communication system.

### BACKGROUND OF THE DISCLOSURE

The millimeter band, adopted in 5G New Radio (NR) and expected to be adopted in 6G, provides high transmission rate. However, the millimeter band has characteristics that high center frequencies ranging from several tens to hundreds of GHz cause propagation attenuation and propagation straightness increases propagation shaded regions. As a technology to overcome these propagation characteristics, beamforming technology has been introduced into base stations and user equipments, and attempts to advance beamforming technology in 6G have been continuously made.

A network-controlled repeater (NCR) is a repeater technology currently being standardized in 3GPP Rel-18. The NCR is a repeater that has a network-controlled beamforming ability in addition to a simple signal reception amplification function of an existing repeater. The unprecedented network-controlled technology and beamforming are key technologies that will overcome shortcomings, such as propagation attenuation and straightness, which occur in the THz ultra-high frequency band expected to be adopted in the 6G communication standard.

### CONTENT OF THE INVENTION

### The Object of the Invention

The present disclosure is directed to providing an apparatus and a method for network-controlled repeater (NCR)-based beam search in a wireless communication system.

In addition, the present disclosure is directed to providing an apparatus and a method for a beam search procedure based on carrier sensing around an NCR in a wireless communication system.

In addition, the present disclosure is directed to providing an apparatus and a method for a beam search procedure based on accumulated data on past successful UE communication experience in a wireless communication system.

### Technical Object of the Invention

According to various embodiments s of the present disclosure, there is provided a beam search procedure performed by a network-controlled repeater (NCR) in a wireless communication system, the beam search procedure including: performing carrier sensing under control of a base station to set a communication-possible area; limiting a beam candidate group on the basis of the communication-possible area to shorten the time taken for beam search; and continuing the carrier sensing even after the beam search procedure is initiated, to update the beam candidate group.

According to various embodiments of the present disclosure, there is provided a beam search procedure performed by a base station (BS) in a wireless communication system, the beam search procedure including: recognizing a communication-possible area through carrier limiting an sensing; area targeted for beam search on the basis of the communication-possible area to shorten the time taken for beam search; and omitting a wide beam search procedure and entering a narrow beam search procedure for the communication-possible area.

According to various embodiments of the present disclosure, there is provided a beam search procedure performed by a user equipment (UE) in a wireless communication system, the beam search procedure including: measuring strength of a signal coming into a base station (BS) or a network-controlled repeater (NCR) to identify a communication-possible area; selecting an optimal beam on the basis of the communication-possible area; and transmitting measurement information including received signal received power (RSRP) or a channel quality indicator (CQI) to the base station.

According to various embodiments of the present disclosure, there is provided a network-controlled repeater (NCR) for a beam search procedure in a wireless communication system, the network-controlled repeater including: a transceiver; and a controller operably connected to the transceiver, wherein the controller is configured to perform carrier sensing under control of a base station (BS) to set a communication-possible area, limit a beam candidate group on the basis of the communication-possible area to shorten the time taken for beam search, and continue the carrier sensing even after the beam search procedure is initiated, to update the beam candidate group.

### Effect of the Invention

The apparatus and the method according to various embodiments of the present disclosure facilitate a beam search procedure that guarantees a high probability of success through beam candidate group setting and update by using carrier sensing around a network-controlled repeater (NCR) and accumulated data past on successful UE communication experience.

Effects that may be obtained from the present disclosure will not be limited to only the above described effects. In addition, other effects which are not described herein will become apparent to those skilled in the art from the following description.

### BRIEF DESCRIPTION OF THE DRAWINGS

FIG. 1 shows an example of an NCR-based wireless communication system, according to various embodiments of the present disclosure.

FIG. 2 shows an example of an NCR structure, according to various embodiments of the present disclosure.

FIG. 3 shows an example of a beam management procedure in a wireless communication system, according to various embodiments of the present disclosure.

FIG. 4 shows an example of access link beam search, according to an embodiment of the present disclosure.

FIG. 5 shows an example of access link carrier sensing, according to an embodiment of the present disclosure.

FIG. 6 shows an example of beam search after access link carrier sensing, according to an embodiment of the present disclosure.

FIG. 7 shows an example of a procedure for NCR beam setting, according to an embodiment of the present disclosure.

FIG. 8 shows a configuration diagram of a base station in a wireless communication system according to various embodiments of the present disclosure.

FIG. 9 shows a configuration diagram of a user equipment in a wireless communication system according to various embodiments of the present disclosure.

FIG. 10 shows a configuration diagram of an NCR according to various embodiments of the present disclosure.

### DETAILED DESCRIPTION OF THE EMBODIMENTS

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure relates to an apparatus and a method for NCR-based beam search in a wireless communication system. Specifically, the present disclosure describes a technology for performing a beam search procedure that guarantees a high probability of success through beam candidate group setting and update by using carrier sensing around a network-controlled repeater (NCR) and accumulated data on past successful UE communication experience in a wireless communication system.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

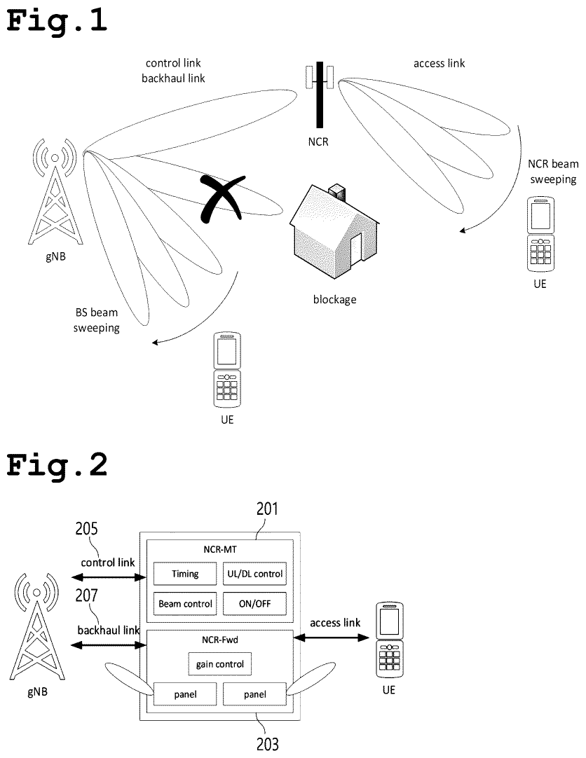

FIG. 1 shows an example of an NCR-based wireless communication system, according to various embodiments of the present disclosure.

Referring to FIG. 1, an NCR has three wireless sections. One of the wireless sections is a section connected to a gNB (base station), and is a control link for transmitting and receiving various types of control information. Another wireless section is a section connected to the gNB, and is a backhaul link in which traffic is exchanged. The other wireless section is a section connected to a user equipment (UE), and is an access link in which traffic is exchanged. The control link and the backhaul link may exist simultaneously or in a time division manner.

The NCR, which is currently being standardized in 3GPP, has the following main characteristics.
(1) Standardization has been discussed in 3GPP Release-18. The standardization has been n discussed mainly focusing on solving beamforming and signal attenuation problems in high frequency bands.
(2) The backhaul link operates only in the same frequency band. The backhaul link of the NCR operates in the same frequency band between the base station and the user equipment. This may increase frequency efficiency and simultaneously simplify link setting.
(3) A single-hop structure is used. By adopting a single-hop structure, additional delay in a relay process is minimized, thus enabling rapid data transfer and reducing network complexity.
(4) There is no mobility. The NCR is a fixed device, and minimizes additional delay in a relay process, thus enabling rapid data transfer and reducing network complexity.
(5) The main roles are signal amplification and simple transfer. Simple transfer may solve the signal attenuation problem even over long distances, and may maintain high transmission performance.
(6) FD duplex is used. That is, simultaneous transmission and reception delays are used. This enables simultaneous transmission and reception in the same frequency band, maximizing data transmission efficiency.
(7) The NCR is transparent to the UE. That is, the UE may perform communication with the base station normally even if the UE is not aware of the existence of the NCR. This improves network performance without disturbing user experience.
(8) On/Off information may be used to save power.

FIG. 2 shows an example of an NCR structure, according to various embodiments of the present disclosure.

Referring to FIG. 2, an NCR is roughly divided into two parts, an NCR-mobile termination (MT) 201 and an NCR-forward (Fwd) 203. The NCR-MT 201 is a device that has a function for exchanging control information and status information with the link, and is a subset of the UE gNB through the control The NCR-MT establishes communication with the gNB function. through the control link that uses a Uu interface (an interface defined for communication between the gNB and the UE). Communication through the control link enables the exchange of side control information, such as beamforming, UL/DL switching, and ON/OFF tuning for managing the NCR-Fwd.

The NCR-Fwd 203 is a function for amplifying DL/UL RF signals or performing beamforming for transfer, and does not include any digital transmission and reception logic. The NCR-Fwd is controlled according to a control signal of the gNB received by the NCR-MT. When the NCR-Fwd first receives a signal from the DL or the UL, the NCR-Fwd performs appropriate beamforming and amplifies the power of the received signal and transfers the signal to the corresponding link, and needs to have an appropriate antenna configuration for performing this.

The large-scale channel characteristics of the control link 205 and the backhaul link 207, which are two of the wireless sections of the NCR, are considered to be the same when at least two links operate in the same band. Therefore, the transmission configuration indicators (TCIs) of the control link and the backhaul link are considered to be the same. On the basis of this, the order of establishment of the wireless sections of the NCR is as follows. First, the control link section is established, and in association with this, the backhaul link is established, and last, the access link is established. In the meantime, the gNB needs to obtain channel state information (CSI) through the NCR and further obtain the number of beams, beam width, and beam directions supported by the NCR. In addition, the NCR needs to report the number of users receiving a service within a coverage to the gNB. On the basis of these information, the gNB may create an effective beamforming strategy for the NCR.

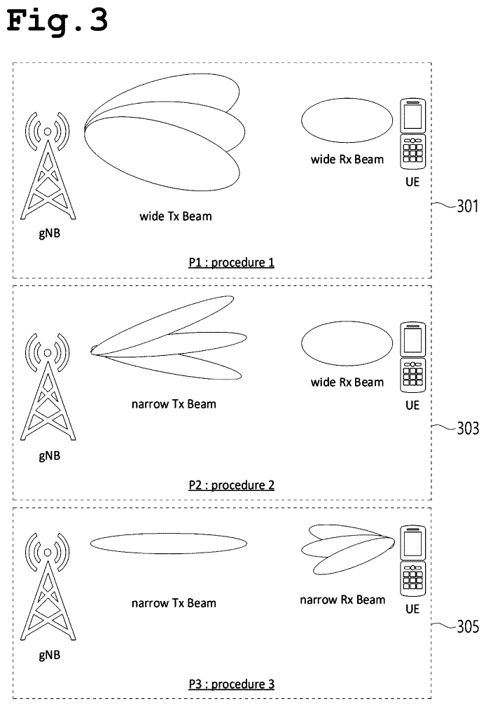

FIG. 3 shows an example of a beam management procedure in a wireless communication system, according to various embodiments of the present disclosure.

Referring to FIG. 3, 5G NR basically applies beamforming technology to a wireless link between a gNB and a UE, so regarding downlink beamforming between a gNB and a UE, the standard may define a three-step beam management procedure as follows.

P-1 301 is an SSB based beam sweeping step, wherein when a UE performs initial access, SSB-based wide beam search between the gNB and the UE is performed. To this end, the gNB repeatedly transmits beams in different directions for respective time slots on the same SSB resource with a particular period, and the user equipment measures RSRP values for the received beams to select an optimal beam.

P-2 303 is a CSI-RS based Tx beam refinement step, wherein using CSI-RS, the gNB transmits beams of a narrower beam width within the width of the wide beam selected in step P-1 and the UE measures the strengths of beams received using the wide beam selected in step P-1 to select a transmission beam.

According to an embodiment, in the present disclosure, a carrier sensing procedure is performed before the wide beam search procedure in step P-1, so that a communication-possible area may be recognized in advance to limit a beam search target. Through this, the wide beam search procedure in step P-1 may be omitted, and the narrow beam search procedure in step P-2 may be directly entered, thus significantly reducing the time taken for beam search. Accordingly, fast communication connection performance is provided, and power consumption is reduced and system resources are efficiently used.

That is, in the present disclosure, a base station may set a communication-possible area through carrier sensing, and may form, on the basis of this, a beam candidate group and perform a beam search procedure. In addition, the base station may update a beam candidate group by using various types of measurement information, such as reference signal received power (RSRP) and a channel quality indicator (CQI), received from a user equipment, thereby improving the accuracy of beam search. Through this, wide beam search (step P-1) is shortened and narrow beam search (step P-2) is directly entered, so that a beam may be efficiently set.

P-3 305 is a CSI-RS based Rx beam refinement step, wherein the gNB fixes the CSI-RS based transmission beam (Tx beam) selected in step P-2 and the UE selects an optimal reception beam through narrower reception beam search within the range of the SSB-based reception beam selected in step P-1.

This beam management procedure between a gNB and a UE in the NR may be applied in a similar way to a system to which an NCR is applied. That is, the NCR-based beam search concept in the present disclosure may be equally applicable to a general base station as well as an NCR having a particular structure. For example, a base station may also recognize a communication-possible area in advance through carrier sensing, and focus, on the basis of this, beam search on the limited area to manage time and resources efficiently. This method is a general beam search technology applicable to both an NCR and a base station, and the wide beam search procedure is shortened and the narrow beam search procedure in step P-2 is directly entered, thereby providing fast connection performance.

The beam search method to establish a wireless link between an NCR and a UE has time-consuming procedures and has a low probability of finding an optimal beam when the UE moves frequently. To solve this problem, the present disclosure proposes a new beam search procedure and method that guarantees a high probability of success through beam candidate group setting and update by using carrier sensing around an NCR and accumulated on data past successful UE communication experience.

As the first step, when there is no connected beam between an NCR and a base station (e.g., gNB), an optimal beam may be found through Uu interface-based beam sweeping between the NCR-MT and the base station to establish control link communication. An in-band method is applied, so backhaul link communication may be automatically established through the above-described procedure.

As the second step, a procedure for establishing access link communication between the NCR and a UE is a procedure before full-scale beam search for setting a link to a UE. In the present disclosure, whether there are UEs that are likely to communicate around the NCR and whether there are shades due to obstacles are recognized in advance through carrier sensing to limit beam candidates to be targeted for beam search and determine beam search directions, thereby reducing the time taken for future beam search.

As the third step, beam search may be performed within the determined beam candidate group and an optimal beam may be selected to perform communication.

As the fourth step, when connection to the UE is made and communication is performed, related beam information is accumulated to update information on the beam candidates set in the previous step, thereby increasing the accuracy of the beam candidate group.

The key technologies proposed in the present disclosure are described in the second and the fourth step of this series of processes. Information on a beam candidate group is updated by introducing the carrier sensing procedure performed in advance to increase the efficiency of beam search and by using continuous information a on surrounding propagation environment.

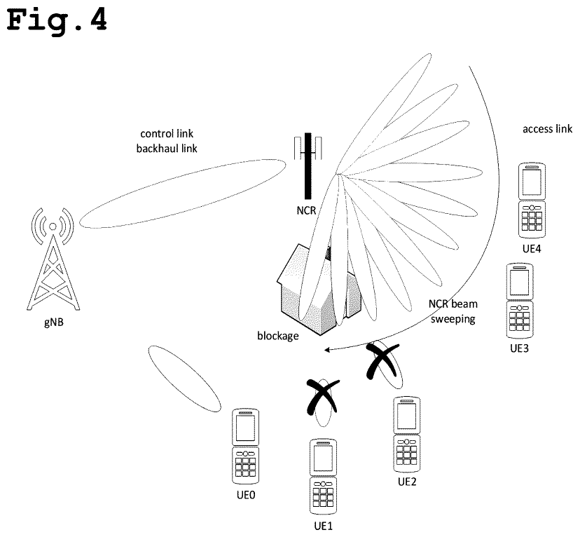

FIG. 4 shows an example of access link beam search, according to an embodiment of the present disclosure.

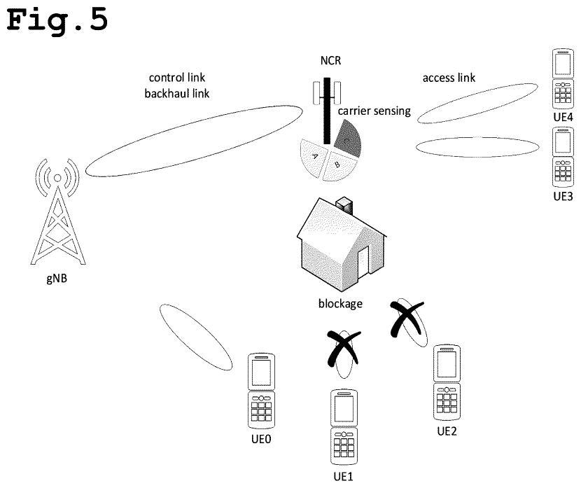

FIG. 5 shows an example of access link carrier sensing, according to an embodiment of the present disclosure.

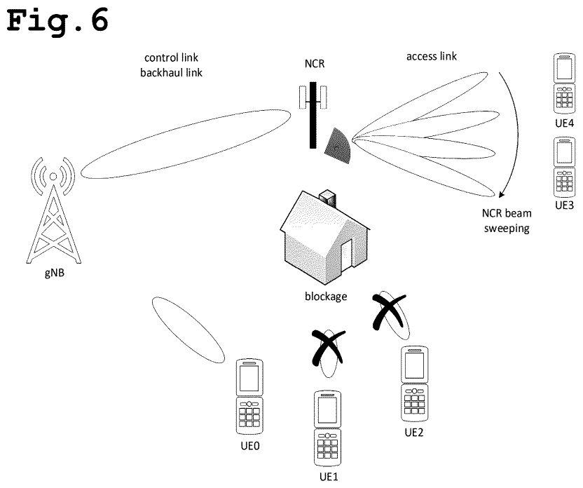

FIG. 6 shows an example of beam search after access link carrier sensing, according to an embodiment of the present disclosure.

Referring to FIG. 4, an NCR may perform beam search in a 360-degree direction around the NCR regardless of shaded regions caused by obstacles and the presence of UEs. This beam search may be inefficient.

Therefore, in the present disclosure, as shown in FIG. 5, a procedure for recognizing the presence of shaded regions and UEs through nearby signal measurement, that is, carrier sensing, is added before beam search, so that a future beam search range is reduced and a beam search procedure may be performed faster and with low power.

Referring to FIG. 5, carrier sensing is to measure the strength of a signal input to an NCR, and may be performed in a variety of ways. According to an embodiment, when a signal of which the strength is greater than a reference strength but weak is measured in a particular direction, it may be assumed that there is a UE at a long distance in the direction. Herein, a narrower beam may be selected as a candidate. Conversely, when the strength of a signal is great, it may be predicted that there is a UE at a short distance or there are multiple UEs. Herein, a wider beam may be selected as a candidate.

In this way, there may be limitations in determining the presence or absence of UEs, distances, or shaded regions using only signal strength. However, the NCR is immobile and fixed at a particular location, so accumulated measurement data may increase the accuracy of determination of a surrounding propagation environment.

According to an embodiment, the carrier sensing procedure may be performed by the base station alone, by the NCR under the control of the base station, or by the NCR alone. Through this, the carrier sensing procedure may be flexibly adjusted to suit various network conditions and system requirements, thereby maximizing the efficiency of beam search.

According to an embodiment, the network-controlled repeater (NCR) may perform carrier sensing under the control of the base station or may perform carrier sensing alone. Herein, a communication-possible area may be set to configure a beam candidate group. In addition, even after the beam search procedure is initiated, carrier sensing may be continuously performed and the beam candidate group may be updated, thereby The NCR may provide data collected setting an optimal beam. during the carrier sensing process to the base station to support the beam setting procedure of the base station.

Referring to FIGS. 5 and 6, a signal is detected in area C through carrier sensing around the NCR and then the NCR may attempt beam search only in area C as shown in FIG. 6. This series of procedures may be managed by the base station (e.g., gNB) through the control link or managed by adding a control unit to the NCR itself.

According to an embodiment, in the carrier sensing procedure, the strength of a signal coming from the user equipment to the base station or the NCR may be measured, the strength of reflected wave of a signal transmitted from the base station or the NCR may be measured, or various measurement indicators (e.g., received signal received power (RSRP), and a channel quality indicator (CQI)) included in messages transmitted and received by the communication protocol may be used. This improves the accuracy of carrier sensing, thus enabling more precise setting of the beam candidate group.

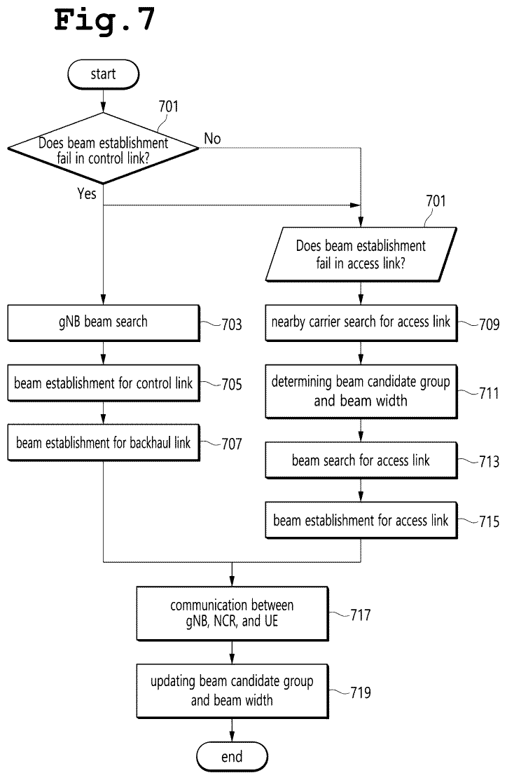

FIG. 7 shows an example of a procedure for NCR beam setting, according to an embodiment of the present disclosure.

Referring to FIG. 7, FIG. 7 assumes that the power of an NCR is turned on or beam failure detection (BFD) occurs in the NCR. That is, this assumes that when the NCR starts operating, the power is turned on or beam failure detection (BFD) occurs, causing a connection problem.

The NCR may determine whether BFD occurs in the control link or the access link in step 701. That is, the NCR may determine the link the beam failure occurs. Afterward, an action to be taken may vary depending on a result of determination.

When BFD occurs only in the control link, the base station may perform beam search in step 703. When BFD occurs only in the control link, the base station may search for a new beam and may set connection to the NCR again.

In response to step 703, the base station may select and establish an optimal beam for the NCR in step 705. That is, the base station may cooperate with the NCR to select and establish an optimal beam in the control link. This process may optimize signal quality.

In response to step 705, the NCR may establish a beam for the backhaul link in step 707. That is, the NCR may select the beam for the backhaul link that is the same as the beam established in step 705. That is, after the beam for the control link is set, the NCR may set the beam for the backhaul link that is the same as the beam for the control link to maintain communication.

When BFD occurs only in the access link, the NCR may perform nearby carrier search for the access link in step 709. That is, when BFD occurs in the access link, the NCR may search for a nearby carrier signal to find candidate beams for communication.

In response to step 707, the NCR may use signal measurement values to determine a beam search candidate group and the beam width in step 711. That is, on the basis of a result of carrier search, the NCR may set a beam search candidate group and determine the width of a beam to perform efficient beam search.

According to an embodiment, the carrier sensing procedure is continuously performed before the beam search procedure is initiated as well as during the search procedure, and through this, the beam candidate group may be updated on the basis of accumulated data. Accordingly, the accuracy of the beam candidate group is increased and an optimal beam may be quickly selected, thereby increasing the reliability of communication connection.

In response to step 709, the NCR may perform beam search for the access link in step 713. That is, when the beam search candidate group is set, the NCR may actually search for a beam in the access link and attempt to make optimal connection.

In response to step 711, the NCR may select and establish an optimal beam for the UE in step 715. That is, the NCR may find an optimal beam to establish stable connection for communication with the UE.

When BFD occurs simultaneously in the control link and the access link, the base station and the NCR may perform steps 703 to 707 and steps 709 to 715 simultaneously. That is, when BFD occurs simultaneously in the two links, the beam search and establishment procedure is simultaneously performed for the control link and the access link to recover the entire connection.

Through the above-described procedure, the base station, the NCR, and the user equipment may perform communication using an established beam in step 715. That is, the base station, the NCR, and the user equipment may perform smooth communication through an established beam.

In response to step 715, the NCR may use information on the connected UE to update information related to the beam candidate group in step 717. That is, the information on the connected UE may be used to continuously update and optimize the beam candidate group used in the beam search process. Accordingly, future beam search may be more efficiently prepared.

According to an embodiment, the carrier sensing procedure is continuously performed before the beam search procedure is initiated as well as during the search procedure, and through this, the beam candidate group may be updated on the basis of accumulated data. Accordingly, the accuracy of the beam candidate group is increased and an optimal beam may be quickly selected, thereby increasing the reliability of communication connection.

Above, the present disclosure proposes an efficient method for beam establishment in a wireless communication system to which an NCR is applied. In a millimetre-wave wireless communication system, the efficiency of beam search needs to be increased to overcome wireless link disconnection due to frequent position changes of a UE and shades and support uninterrupted communication. To this end, in the present disclosure, during a beam establishment step for an initial access link, the strength of nearby RF signals is measured, specifically, nearby UEs that will be connected to a gNB in the future are estimated through carrier sensing, before full-scale beam search. Accordingly, optimized beam width, beam directions, and the number of beams are selected, thereby performing faster and power-efficient beam search. In addition, even after connection to a UE is made, information on a beam candidate group is updated on the basis of continuous search for nearby signals and information on the connected UE, thereby establishing a stable wireless link.

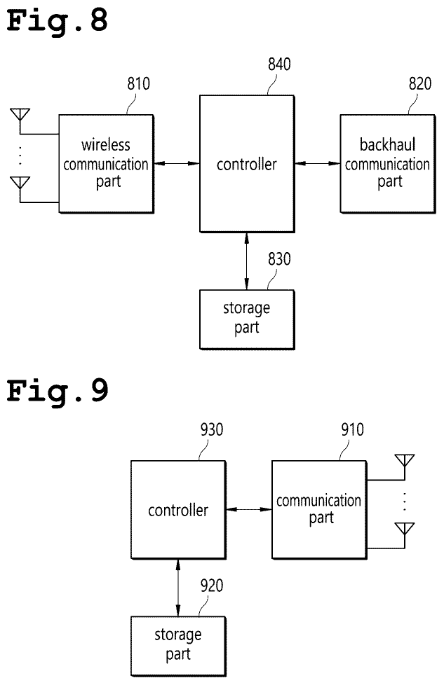

FIG. 8 shows a configuration diagram of a base station in communication system a wireless according to various embodiments of the present disclosure. The configuration illustrated in FIG. 8 may be understood as a configuration of a base station. The terms “˜part”, “˜unit”, and the like used below mean a unit for processing at least one function or operation, and may be implemented by hardware, software, or a combination of hardware and software.

Referring to FIG. 8, the base station may include a wireless communication part 810, a backhaul communication part 820, a storage part 830, and a controller 840.

The wireless communication part 810 may transmit and receive wireless signals through a wireless channel. For example, the wireless communication part 810 may perform a function of conversion between a baseband signal and a bit string according to the physical layer standards of a system. In addition, when transmitting data, the wireless communication part 810 may generate complex symbols by encoding and modulating a transmission bit string. When receiving data, the wireless communication part 810 may restore a reception bit string by demodulating and decoding a baseband signal.

In addition, the wireless communication part 810 may up-convert a baseband signal into a radio frequency (RF) band signal and transmit the RF band signal through an antenna, and may down-convert an RF band signal received through an antenna into a baseband signal. To this end, the wireless communication part 210 may include a transmission filter, a reception filter, an amplifier, a mixer, an oscillator, a digital-to-analog converter (DAC), and an analog-to-digital converter (ADC).

The wireless communication part 810 may include multiple transmission and reception paths. The wireless communication part 810 may include at least one antenna array composed of multiple antenna elements.

In terms of hardware, the wireless communication part 810 may include a digital unit and an analog unit. The analog unit may include multiple sub-units according to operating power or operating frequency. The digital unit may be realized as at least one processor (e.g., digital signal processor (DSP)).

The wireless communication part 810 may transmit and receive wireless signals as described above. Accordingly, all or part of the wireless communication part 810 may be referred to as a “transmitter”, “receiver”, or “transceiver”. In addition, in the following description, transmission and reception performed through a wireless channel may include the above-described processing performed by the wireless communication part 810.

The backhaul communication part 820 may provide an interface for performing communication with other nodes in the network. That is, the backhaul communication part 820 may convert bit strings transmitted from the base station to other nodes, such as other access nodes, other base stations, a parent node, and a core network, into physical signals, and may convert physical signals received from other nodes into bit strings.

The storage part 830 may store therein data, such as default programs, application programs, and setting information for the operation of the base station. The storage part 830 may be a volatile memory, a non-volatile memory, or a combination of a volatile memory and a non-volatile memory. In addition, the storage part 830 may provide stored data according to a request of the controller 840.

The controller 840 may control overall operations of the base station. For example, the controller 840 may transmit and receive signals through the wireless communication part 810 or the backhaul communication part 820. In addition, the controller 840 may record data on the storage part 830 and may read the data. In addition, the controller 840 may perform functions of a protocol stack that communication standards require.

To this end, the controller 840 may include at least one processor.

According to various embodiments of the present disclosure, the controller 840 may perform control so that the above-described base station performs the operations according to various embodiments.

FIG. 9 shows a configuration diagram of a user equipment in a wireless communication system according to various embodiments of the present disclosure. The configuration illustrated in FIG. 9 may be understood as a configuration of a user equipment. The terms “˜part”, “˜unit”, and the like used below mean a unit for processing at least one function or operation, and may be implemented by hardware, software, or a combination of hardware and software.

Referring to FIG. 9, the user equipment may include a communication part 910, a storage part 920, and a controller 930.

The communication part 910 may perform functions for transmitting and receiving signals through a wireless channel. For example, the communication part 910 may perform a function of conversion between a baseband signal and a bit string according to the physical layer standards of a system. For example, when transmitting data, the communication part 310 may generate complex symbols by encoding and modulating a transmission bit string. When receiving data, the communication part 910 may restore a reception bit string by demodulating and decoding a baseband signal. In addition, the communication part 910 may up-convert a baseband signal into an RF band signal and transmit the RF band signal through an antenna, and may down-convert an RF band signal received through an antenna into a baseband signal. For example, the communication part 910 may include a transmission filter, a reception filter, an amplifier, a mixer, an oscillator, a DAC, and an ADC.

In addition, the communication part 910 may include multiple transmission and reception paths. Furthermore, the communication part 910 may include at least one antenna array composed of multiple antenna elements. In terms of hardware, the communication part 910 may be a digital circuit and an analog circuit (for example, a radio frequency integrated circuit (RFIC)). Herein, the digital circuit and the analog circuit may be realized as one package. In addition, the communication part 910 may include multiple RF chains. Furthermore, the communication part 910 may perform beamforming.

The communication part 910 transmits and receives signals as described above. Accordingly, all or part of the communication part 910 may be referred to as a “transmitter”, “receiver”, or “transceiver”. In addition, in the following description, transmittion and reception performed through a wireless channel may be used to mean that the communication part 910 performs the above-described processing.

The storage part 920 may store therein data, such as default programs, application programs, and setting information for the operation of the user equipment. The storage part 920 may be a volatile memory, a non-volatile memory, or a combination of a volatile memory and a non-volatile memory. In addition, the storage 920 may provide stored data according to a request of the controller 930.

The controller 930 may control overall operations of the user equipment. For example, the controller 930 may transmit and receive signals through the communication part 910. In addition, the controller 930 may record data on the storage 920 and may read the data. The controller 930 may perform functions of a protocol stack that communication standards require. To this end, the controller 930 may include at least one processor or microprocessor, or may be part of a processor. In addition, part of the communication part 910 and the controller 930 may be referred to as a communication processor (CP).

According to various embodiments, the controller 930 may perform control so that the above-described user equipment performs the operations according to the various embodiments.

In the present disclosure, the user equipment may measure the strength of a signal coming into a base station or an NCR through carrier sensing and may recognize information on a communication-possible area. The user equipment periodically reports its measurement information, such as the RSRP and the CQI, to the base station, contributing to the updating of the beam candidate group. This helps the base station to set an optimal beam. In addition, the user equipment may select, on the basis of the measured signal strength information, an optimal beam from the beam candidate group provided by the base station, thereby improving communication performance.

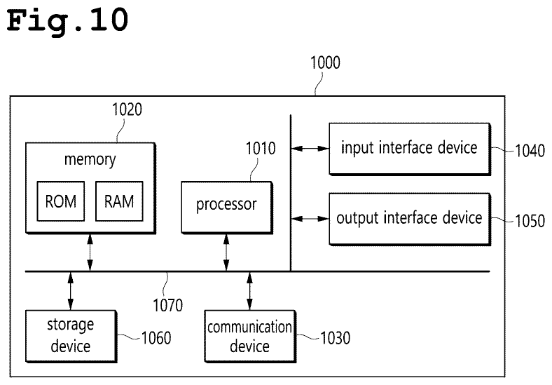

FIG. 10 shows a configuration diagram of an NCR according to various embodiments of the present disclosure.

Referring to FIG. 10, the NCR 1000 may include at least one processor 1010, a memory 1020, and a communication device 1030 that is connected to a network to perform communication. In addition, the NCR 1000 may further include an input interface device 1040, an output interface device 1050, and a storage device 1060. Each of the elements included in the NCR 1000 may be connected by a bus 1070 to communicate with each other.

However, with the processor 1010 in the center, each of the elements included in the NCR 1000 may be connected via an individual interface or an individual bus, rather than the common bus 1070. For example, the processor 1010 may be connected via a dedicated interface to at least one of the following: the memory 1020, the communication device 1030, the input interface device 1040, the output interface device 1050, and the storage device 1060.

The processor 1010 may execute program commands stored in either the memory 1020 or the storage device 1060 or both. The processor 1010 may refer to a central processing unit (CPU), a graphics processing unit (GPU), or a dedicated processor on which methods according to embodiments of the present disclosure are performed. Each of the memory 1020 and the storage device 1060 may include either a volatile storage medium or a non-volatile storage medium or both. For example, the memory 1020 may include either read-only memory (ROM) or random-access memory (RAM) or both.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A beam search procedure performed by a network-controlled repeater (NCR) in a wireless communication system, the beam search procedure comprising:
performing carrier sensing under control of a base station to set a communication-possible area;
limiting a beam candidate group on the basis of the communication-possible area to shorten the time taken for beam search; and
continuing the carrier sensing even after the beam search procedure is initiated, to update the beam candidate group.

2. The beam search procedure of claim 1, wherein information on the beam candidate group set through the carrier sensing is updated, and an optimal beam search procedure is transmitted to the base station.

3. The beam search procedure of claim 1, wherein the carrier sensing is to
adjust a width of beam search on the basis of strength of a signal received in a particular direction, and
set a narrow beam or wide beam candidate group according to a communication environment.

4. The beam search procedure of claim 1, further comprising
optimizing the beam search procedure on the basis of beam setting-related information received from the base station.

5. A beam search procedure performed by a base station (BS) in a wireless communication system, the beam search procedure comprising:
recognizing a communication-possible area through carrier sensing;
limiting an area targeted for beam search on the basis of the communication-possible area to shorten the time taken for beam search;
omitting a wide beam search procedure and entering a narrow beam search procedure for the communication-possible area.

6. The beam search procedure of claim 5, further comprising
updating a beam candidate group on the basis of measurement information including received signal received power (RSRP) and a channel quality indicator (CQI) received from a user equipment (UE).

7. The beam search procedure of claim 5, wherein the carrier sensing uses strength of a signal coming into a user equipment (UE), strength of reflected wave of a signal transmitted from the base station, or a measurement indicator included in a message of communication protocol.

8. The beam search procedure of claim 5, further comprising:
updating a beam candidate group according to a moving path of a user equipment (UE); and
adjusting the area targeted for beam search dynamically according to the moving path.

9. A network-controlled repeater (NCR) for a beam search procedure in a wireless communication system, the network-controlled repeater comprising:
a transceiver; and
a controller operably connected to the transceiver, wherein the controller is configured to
perform carrier sensing under control of a base station (BS) to set a communication-possible area,
limit a beam candidate group on the basis of the communication-possible area to shorten the time taken for beam search, and
continue the carrier sensing even after the beam search procedure is initiated, to update the beam candidate group.

10. The network-controlled repeater of claim 9, wherein the controller is further configured to update information on the beam candidate group set through the carrier sensing, and transmit an optimal beam search procedure to the base station.

11. The network-controlled repeater of claim 9, wherein the controller is configured to, for the carrier sensing,
adjust a width of beam search on the basis of strength of a signal received in a particular direction, and
set a narrow beam or wide beam candidate group according to a communication environment.

12. The network-controlled repeater of claim 9, wherein the controller is configured to optimize the beam search procedure on the basis of beam setting-related information received from the base station.
